(19) United States
(12) Patent Application Publication
(10) Pub. No.: US 2007/0270984 A1
(43) Pub. Date: Nov. 22, 2007

(54) Method and Device for Redundancy Control of Electrical Devices

(76) Inventors: Norbert Lobig, Darmstadt (DE); Jurgen Tegeler, Penzberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/665,509

(22) PCT Filed: Sep. 16, 2005
(86) PCT No.: PCT/EP05/54609

§ 371 Date: Apr. 13, 2007

(30) Foreign Application Priority Data
Oct. 15, 2004 (DE) 10 2004 050 350.8

(51) Int. Cl. G05B 9/02

(52) U.S. Cl. 700/82

(57) ABSTRACT

In general, electrical units have to meet the requirements for high reliability and a high level of operational safety. This applies in particular to communications systems where the constant availability of all devices is necessarily required. For this reason, computer capacity is held in reserve in order to guarantee operational safety, so that in the event of failure of an electrical device, the currently-running functions can be transferred to additional (active) electrical devices. The control of these processes is carried out by a redundancy control. However, the problem associated with prior art remains, whereby all processes for redundancy control are expensive or unreliable, sometimes even both. An aspect of the invention provides a solution by virtue of the fact that each of the electrical devices is monitored by an additional electrical device and that, optionally, each of these devices, in turn, monitors at least one of the electrical devices.

### CROSS REFERENCE TO RELATED APPLICATIONS

This application is the US National Stage of International Application No. PCT/EP2005/054609, filed Sep. 16, 2005 and claims the benefit thereof. The International Application claims the benefits of German application No. 102004050350.8 DE filed Oct. 15, 2004, both of the applications are incorporated by reference herein in their entirety.

### FIELD OF INVENTION

The present invention relates to a method and device for redundancy control of electrical devices.

### BACKGROUND OF INVENTION

In general, electrical units are expected to have a high level of reliability and operational safety. This applies in particular to communications systems where the constant availability of all devices is necessarily required (high availability). For this reason, computer capacity is held in reserve in the communications system in order to guarantee operational safety, so that in the event of failure of an electrical device, the functions currently running can be transferred to additional (active) electrical devices. If the latter have already been prepared for such an event so that they can directly take over the functions without having to be reconfigured or re-installed, for example, this is referred to as redundancy. In order to be able to transfer the functions of electrical devices to other electrical devices quickly, safely and comprehensibly in the event of failure thereof, a redundancy control is required. The function thereof is to check the state of all electrical devices regularly in order to know the current operational state of all electrical devices even prior to a possible failure so that it is possible to control the switchover of functions effectively should an electrical device fail.

The prior art basically distinguishes between two architectures for redundant systems:

(i) First, a plurality of devices are provided, the devices being completely homogeneous with respect to the application for which they make redundancy available. Thus a resource pool having a plurality of devices is defined, which in the event of a fault, assigns resources on functioning devices (for example, MGCP protocol, code receiver, echo canceller) to the applications running on an electrical device that has faults. If the faulty device goes back into operation it is restored to the resource pool again and is available to the applications again. The resources on other devices, which have been used in the interim, then become free once again.

(ii) Second, there exist configurations in which at least certain applications in the block are migrated from one electrical device in the event of a failure thereof to another electrical device (for example, H 248 protocol). The latter device is assigned to transfer the function or prepared by continuously updated data, for example, only the basic and fast transfer of the function being facilitated. Selection of the redundant unit from a pool is not sufficient in this case, since the preparative work involved would be too complex and laborious, which would have undesirable effects on the required availability of the function.

### SUMMARY OF INVENTION

Whilst simply achieved effective and safe methods of redundancy control can be implemented for scenario (i), the known methods of redundancy control have a number of serious drawbacks in scenario (ii). In this case, an additional controller is generally required in order to monitor the redundant electrical devices and switch to a standby mode in the event of failure. In order to fully satisfy high availability requirements, the controller itself also has to be redundant in its own right. A redundancy mechanism likewise has to exist for this. The redundancy control is only safe when such an outlay has been made and the control thus meets real time requirements, in most cases at least. Such systems are very expensive, however.

According to a further prior art, provision is made for two electrical devices to permanently monitor each other. To this end, one of the electrical devices is directed into an active operational state (act), whilst the remaining electrical device remains in a ready or standby operational state (stb). In this case, all the applications of the electrical devices that are in the standby operational state are deactivated. If the latter now decides that the active electrical device has failed, it switches to an active operational state.

This method involves a relatively large risk of a “split-brain” scenario occurring. In the split-brain scenario, the two redundancy partners no longer consistently align their operational states with each other. This means that both partners can be in the standby or active operational state. It can also occur that both systems oscillate synchronously between the active and standby operational state. Sometimes such an event can only be rectified manually. The effects of such a scenario can cause havoc with the whole operation. The risk of a split-brain scenario occurring should therefore be avoided by selecting a highly reliable redundancy method.

It is certainly true that the aforementioned risk can be reduced at concept level by having the decision regarding (act/stb) between two redundancy partners made by a third neutral unit which then informs all the affected electrical devices of its decision and then compels them to assume a certain state. Such a solution has already been suggested for communications systems. In this solution, the central control device, which has high availability, assumes the function of redundancy control over the peripheral electrical devices. This again results in the (expensive) configuration mentioned in the introduction. Basically, the prior art can be described as expensive or unreliable (sometimes even both).

An underlying object of the invention is therefore to find a method and provide a device that represent an efficient and cost-effective method of redundancy control for electrical devices.

The advantage inherent in the invention is the provision of a simple and efficient redundancy mechanism that does not require any additional hardware for redundancy control and at the same time guarantees maximum availability and operational safety. This is achieved by providing a two-step redundancy control, the first step (control 1) having at its disposal a neutral third channel which decides which standby circuit to switch to within a redundancy pair (redundancy unit). This concept considerably reduces the risk of split brain. Here the controlling pair is also the controlled pair at the same time. There is therefore no separate mechanism for the controller's switchover to standby, which makes redundancy control conceivably simple and efficient. All the platforms of the redundancy control unit can be loaded with applications that require a redundancy control, meaning that no additional hardware is required. One and the same method means that both the controlling and the controlled unit have high availability.

Furthermore, a second step (control 2), which describes the control within a redundancy unit is optionally provided. It can be provided in addition to the first step. The combination of both steps has the advantage of a particularly robust redundancy configuration that can even survive multiple failures of electrical devices within the quadruple. In practice, this means that, whenever there is a still a functional platform for a function capable of switching over to standby, this platform redirects the dedicated services.

It is equally advantageous that this does not result in any negative repercussions on the system. Thus simple handling ensues when the moving the system up from the controlling to the controlled unit. For this purpose, it is possible to move the platforms up in any sequence. The system is capable of operation as soon as the first platform is “act”. In any combination of platforms that are capable of being functional and have failed, the system is the state of maximum redundancy and maximum availability.

Furthermore, it is particularly advantageous that the redundancy handling is supported by functions or processes that run or are allowed to run in a certain form (for example, in conjunction with a certain peripheral) on only one platform at the same time in each case (for example, H.248, where simultaneous access of various MGCs to one MG (which is virtual in the sense of the H.248.1 standard) is not permissible, which functions and processes have to have high availability, however. This includes act/act redundancy, act/stb redundancy and also n+m redundancy. Functions and processes that do not have this restriction (for example, MGCP where simultaneous access of various MGCs to a single port of an MGCP-controlled MG is permissible per standardization) can be operated on the redundancy unit in server farm architecture. For these, the introduction of the method is completely transparent. This means that the use of the method does not have any repercussions on finctions that do not require it and it can thus also be easily introduced into existing systems.

Advantageous developments of the invention are set out in the dependent claims.

### BRIEF DESCRIPTION OF THE DRAWINGS

The invention is described in more detail hereafter with the aid of an exemplary embodiment shown by means of the figures.

The figures show:

FIG. 1 a redundancy control unit RCU having t redundancy units RU₁, RU₂, RU₃, RUₜ,

FIG. 2 the circumstances in a communications system, consisting of a server farm controller having servers (platforms) of a plurality of redundancy units, said servers being disposed in pairs,

FIG. 3 a case study, according to which a superordinate device (server farm controller SFC) has no knowledge of any kind of the operational state of the individual platforms (servers) of a plurality of redundancy units,

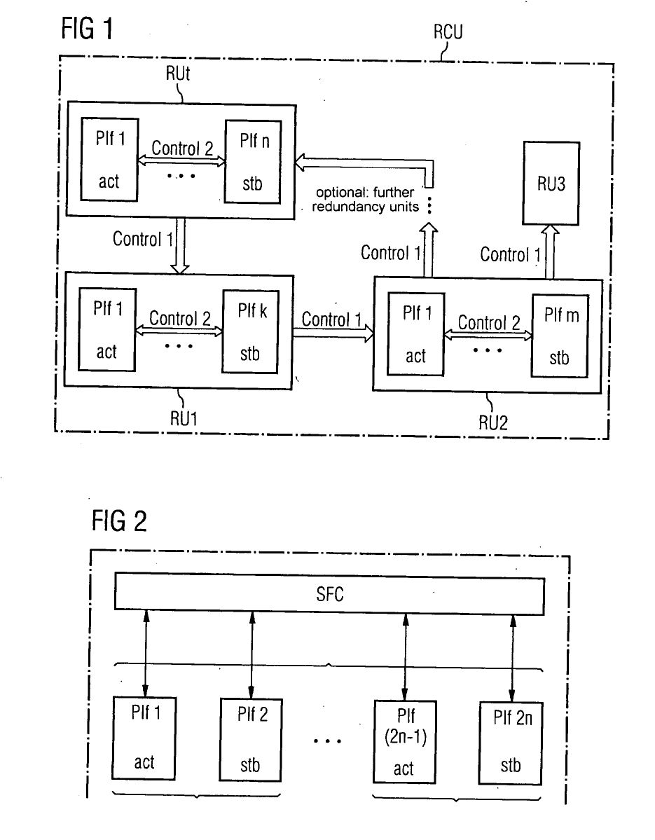

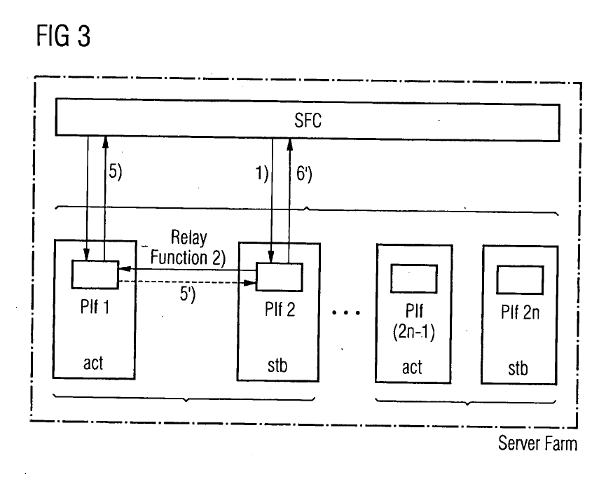

### DETAILED DESCRIPTION OF INVENTION

FIG. 1 shows a redundancy control unit RCU (redundancy control unit) with, for example, four redundancy units RU₁, RU₂, RU₃, RUₜ. Here a redundancy unit comprises a plurality of electrical devices, which are configured in the present exemplary embodiment as HW/SW platforms. Each redundancy unit may have a number k, l, m, n of platforms that differs from the other redundancy units. The platforms have the feature that each function/application running on a platform of the redundancy unit can be taken over by each other platform of the redundancy unit.

FIG. 1 shows a configuration in a general form. This shows a ring topology of redundancy units (each RU monitors its successor and is itself monitored by its predecessor. For the mechanism to function, however, it is by no means necessary for each RU to both monitor and be monitored. It is only necessary for each RU to be monitored by another. That is, an RU can monitor a plurality of other RUs but each RU in the RCU is monitored by precisely one other RU. Thus even quasi- star-shaped topologies are conceivable (for example, RU₁ monitors RU₂, RU₃ and RUₜ. RU₂ monitors RU₁). In the simplest case, the number of platforms within a redundancy unit k=l=m=n=2. This results in one (platform) redundancy pair per redundancy unit. Likewise in the simplest case, a redundancy control unit RCU will be provided with only two redundancy units. Thus the redundancy control unit RCU is formed of two redundancy units and these again are each formed of two platforms, with which a quadruple is defined. On the platforms of a redundancy pair, states distinguishable from each other are maintained, said states being referred to hereafter as act (active operational state) and stb (ready or standby operational state). An application that requires a redundancy control can use these states as an indicator to control the redundancy function thereof.

The redundancy control unit RCU shown in FIG. 1 represents two-step redundancy control/redundancy monitoring. Step 1 is represented by a control function Control 1 and step 2 by a control function Control 2. The overall functionality is formed by the two control functions Control 1 and Control 2 and represents the redundancy control.

In step 1, the redundancy units monitor each other reciprocally. The monitoring is achieved in such a way that each redundancy unit is monitored by a maximum of one other redundancy unit and for its part monitors none, one or a plurality of redundancy units. In the special case of a quadruple, each redundancy partner thus controls the “fail over” in the partner redundancy pair of the redundancy control unit RCU and is thus both controller and controlled. The controller monitors and determines the states of all platforms within the controlled redundancy pair. It thus has the task of ensuring consistency with respect to redundancy (that is, only one platform in “act” in each case) within the redundancy pair. Control is achieved by means of regular checking of the communications link with the assigned redundancy pair. If the controller detects that communication with a platform in the “act” state is interrupted for a certain period, it attempts to deactivate said communication, that is to give it the “stb” state, and activates the redundancy partner thereof (by inputting the “act” state).

Control messages are provided for implementing this function. Said messages are transmitted via the control function Control 1 at least by the platform that is in the active operational state in the monitoring redundancy pair. The control messages optionally contain parameters such as, for example, “go to act/stb”, by means of which they inform the receiver that it is to switch to the active or standby operational state. This parameter is always set when the transmitter has the information as to which of the two platforms should be “act” and which “stb”. The acknowledgements to control messages contain the state of the controlled platforms (act/stb).

In the case of dual failure of the monitored redundancy pair or after the controller has run through a recovery process, the latter has no information at all regarding the operational state of the controlled redundancy unit. In this case, the controller has two options of assigning states to the monitored platforms (act/stb). Either it takes the relevant information from their acknowledgements and adopts it, or alternatively, it assigns the active operational state to the first platform which acknowledges (again). By virtue of the fact that the parameter “go to act/stb” is always set when it can be, maximum safety is achieved. If, in spite of all the precautionary measures, a case of split brain should occur (that is, both controlled platforms in act or both in stb), the controller detects this in the acknowledgement and is immediately able to put it right by means of a monitoring message with “go to act”/“go to stb”. Since the frequency of the monitoring messages (depending on performance and utilization of the platforms and message pathways) should be selected to be as high as possible (for example, 10/s), a split brain scenario would thus be put right very quickly, which is a further advantage of the invention.

Step 2 describes the control within a redundancy unit. It can be provided in addition to the control function Control 1 and ensures consistent (act/stb) states within a monitored redundancy unit (that is, only one platform is allowed to be active) if Control 1 has failed. This occurs by means of an internal reciprocal monitoring of the platforms, the results of which are likewise used to control the redundancy states (act/stb) of the platforms of the redundancy unit. Control 2 operates autonomously and is thus in a position to provide another switchover to standby function within the redundancy pair in the event of failure of the control function Control 1.

Inversely, the results of Control 2 can preferably be evaluated only when Control 1 has failed. That is, whenever Control 1 is active, in this case it also has redundancy control. Control 2 is constantly running too, and immediately takes over control if Control 1 fails. As a result of clear separation of responsibilities, a simple software structure can be achieved and the risk of a conflict of responsibility between Control 1 and Control 2 can be avoided. Control 2 needs to be active only on the monitored redundancy unit. The messages exchanged in the context of Control 1 and Control 2 can contain both setting information regarding the functions that are to be switched to alternatively (ACT/STB) and further information, such as, for example, availability of the communication from the addressed platform to the further platforms of the redundancy unit thereof or of the controlling redundancy unit. This increases the safety of the redundancy control and avoids unnecessary switching operations, for instance in the event that the active platform cannot be accessed by the controlling platform for a short time, but an STB platform of the controlled redundancy unit is accessible and announces that it itself is in communication with the active platform.

The acknowledgements to control messages can also contain other information that is relevant for the controller's decision as to which platform is to be act and which is to be stb. For instance, a relevant criterion can be whether the platforms of the RU are in contact with other units in the system as a whole. If the stb has a better connection status in this case, that could be a reason for switching over.

In the case of platforms disposed in pairs in a redundancy unit, the control function control 2 within the redundancy pair is implemented in such a way that only the active platform regularly transmits control commands to its redundancy partner. The active platform monitors whether its control messages are being acknowledged. Both platforms in the redundancy pair monitor whether they are receiving control commands from the redundancy partner. With the aid of the control function Control 2, each platform in the redundancy pair obtains information as to whether its partner platform is communicating with it at all and if this is the case, as to what state (act/stb) the partner platform is in.

For implementation, care must be taken to ensure that the controlled platform autonomously becomes active if no control commands have come from the redundancy partner for a certain time. Furthermore, each acknowledgement to a control command must contain the state (act/stb) of the receiver of the control command. Over and above this, in each cycle (control command/acknowledgement), each of the two platforms has to check its own state against that of the redundancy partner (the sender of a control command always has to be active). If there is an inconsistency (for example, both platforms being in the active operational state), this can be eliminated by, for example, each of the platforms then reverting to its default redundancy state (which naturally provides only one active platform within the redundancy pair). For safety's sake, an additional examination of the internal communications network should take place in order to rule out the possibility of a failure of said network leading to several platforms of a redundancy unit becoming active.

FIG. 1 starts by assuming that one of the redundancy units, for instance the redundancy unit RUₜ, represents the controlling redundancy unit. It monitors the communications links between itself and all the platforms Plf1 . . . Plfk of the controlled redundancy unit (for instance, RU₁) The controlling redundancy unit RUₜ also sets the states (act/stb) on all the platforms Plf1 . . . Plfk of the controlled redundancy unit RU₁ and is responsible for ensuring that these are consistent, that is, that only one platform in the controlled redundancy unit RU₁ is in the active operational state. At the same time, the redundancy unit RUₜ is controlled by a further redundancy unit. This can be the redundancy unit RU₂, for instance.

If the communications link between the controlling redundancy unit RUₜ and the platform of the controlled redundancy unit RU₁ that is in the active operational state (for example, platform k) fails for a certain time, then the controlling redundancy unit RUₜ decides that platform k has failed (it could also merely be that the connection is broken although platform Plfk is in order). Consequently, another platform of the controlled redundancy unit RU₁ (for example, platform Plfk-1) is then switched into the active operational state and platform k (as soon as this is responsive again) is switched over to the standby operational state. The high availability of the controlling redundancy unit RUₜ also extends to the control function Control 1. This means that even in the event of partial failure of the controlling redundancy unit RUₜ, the function Control 1 is still available.

The two-stage control function allows the simple control of relevant failure scenarios, system start-up and upgrade within the redundancy control unit RCU. Even in the event of the failure of a plurality of platforms, the theoretically maximum possible functionality can always be provided in each case.

1. Failure of an active platform:

In this case it is assumed that the active platform Plf1 controlled by the platform Plf3 has failed. Said platform is thus no longer responding to control commands from platform Plf3. Platform Plf3 monitors whether its control commands are being acknowledged. If no acknowledgement has been received for a certain number of control commands and there is likewise no indication to the contrary from the communication with platform Plf2, which is redundant to platform Plf1, platform Plf3 concludes that platform Plf1 has failed and from now on puts the parameter “go to stb” in the control messages to platform Plf1 and the parameter “go to act” in the control messages to platform Plf2. Platform Plf2 then switches to “act”. Platform Plf1 will generally fail to receive the message at first because of recovery or a fault. At some time or other, however, platform Plf1 will have completed its recovery or is repaired and goes back into operation, receives the message and goes to “stb”. At the same time, however, platform Plf1 could have control (Control 1) over the redundancy pair controlling its redundancy unit, that is, platforms Plf3 and Plf4. With the failure of platform Plf1, the control function Control 1 then also fails, which should not initially result in any changes to the “act/stb” configuration in the controlled redundancy pair. Platforms Plf3/Plf 4 thus continue to operate unchanged. After a relatively short time, platform Plf2 is then in “act” and according to what we have assumed, takes over “Control 1” over platforms Plf3/4. This takeover likewise does not generally result in a switchover between Plf3 and Plf4.

2. Failure of a Standby Platform:

In this case it is assumed that platform Plf2 has failed. The failure does not result in a switchover by platform Plf3. Platform Plf3 continues to send commands with “go to act” to platform Plf1 and “go to stb” to platform Plf2. At some time or other, platform Plf2 will have completed its recovery or will be available again after repairs, receives the message saying “go to stb” and accordingly goes to stb.

3. Dual Failure of a Redundancy Pair:

In this case it is assumed that platforms Plf1 and Plf2 have failed. If the last platform Plf of the redundancy pair has failed, the act/stb information in the controller (Plf3) is invalid and should be deleted. Accordingly, control commands no longer set the parameter “go to act/stb” from this time on. However, the control commands continue to be transmitted to both platforms. The first platform to acknowledge the command is designated as “act” in the controller (the acknowledgement does not indeed contain the act/stb state of the receiver of the control command). From this point on, “go to act/stb” can again be included in the control commands. This ensures that, whenever one of the two platforms in a redundancy pair is available, said platform is immediately in the “act” state and provides the services of the platform.

With the dual failure of platforms Plf1 and Plf2, the control function Control 1 of Plf1/Plf2 over Plf3/Plf4 also fails. This is noted in platforms Plf3/Plf4. After a certain safety interval, which should be longer than the switchover described under 1, the evaluation of the control function Control 2 on Plf3/Plf4 is activated if it is not continuously active. This still makes available an additional switchover function on Plf3/Pif4, as described above. This means that the redundancy unit consisting of platforms Plf3/Plf4 provides its services unchanged and is still very much available.

If, for example, platform Plf3 still fails as the active platform, then platform Plf4 observes that the control commands from platform Plf3 are absent and, after a certain time, moves of its own accord to “act”. This means that even where three platforms have failed within the redundancy control unit, the fourth is basically “act” and provides the maximum service in the circumstances. It also provides the control function Control 1 over platforms Plf1/Plf2 and also the control function Control 2 over platform Plf3. That is, if one of said platforms becomes available again, it automatically switches to the state that is right for it.

Particularly in the event that the control only continues to be achieved via control function 2, there is an increased risk of the split brain scenario occurring due to interference with the communication between the platforms. The use of an at least dual messaging system between the participating platforms counteracts this risk.

4. System Start-Up

In the normal event, any platform in the quadruple can be the first to complete its recovery. Therefore the intersection of control messages does not occur. If a platform has completed the recovery of its remaining functionality (with the exception of redundancy control) and is consequently able to run, it has to run through a handling procedure specific to redundancy control in order to decide whether it is in the “act” or “stb” state as far as redundancy control is concerned. For this purpose it defines a specific safety period during which it listens to determine what control commands it is receiving. There are three distinct scenarios:
(i) The platform receives a command to “Control 1” (with or without additionally receiving a command to “Control 2”). The “Control 1” platform is then activated. It is informed in the next “Control 1” command at the latest as to whether it is on “act” or “stb”.
(ii) Although the platform does not receive a command to “Control 1”, it does receive a command to “Control 2”. From this the platform concludes that its redundancy partner is in the “act” state and moves accordingly to “stb”.
(iii) The platform does not receive a command either to “Control 1” or one to “Control 2”. From this the platform concludes that its redundancy partner is not in the started up state and moves of its own accord to “actp”.

The normal scenario is that one platform of the participating redundancy units is the first to complete its recovery. If, however, in a plurality of redundancy units that control each other, platforms complete their recovery in such close succession that the mechanism of control function Control 1 cannot ensure consistent (act/stb) states of the respective controlled redundancy unit, all these platforms thus become “act” autonomously practically at the same time. This is not a problem because the respective controlled “act” platforms take over the control function Control 1 over the platforms that are to be controlled and subsequently “learn” the state thereof (at least that of the “act” platform). This means that the control function Control 1 adapts to the given allocation of functions.

A particular feature of the method according to the invention is that it makes provision for the following special case:

If, without being controlled as per Control 1, both platforms in a redundancy pair complete their recovery or their restart after repair in such close succession that the mechanism of control function Control 2 cannot ensure consistent (act/stb) states, initially both platforms in the redundancy pair autonomously go to “act” and send control commands to their redundancy partner. This is immediately noted by both platforms, however, and the aforementioned correction mechanism goes into effect. Both platforms go into the default (act/stb) defined by the system administrator or by fixed programming. In this way consistency is restored.

5. System Upgrade:

A system upgrade, too, can be implemented very easily with the suggested method and carried out with minimum detriment to the system stability of the redundancy units.

To carry out an upgrade, one of the platforms in a redundancy pair, for instance platform Plf1, is initially deactivated. Platform Plf2 is then automatically directed into the active operational state (if it was not in this state already), and the control function Control 1 remains active on both platforms. This still provides a very high level of availability and safety of the three remaining platforms, which are ready to function. There is of course the option for the “stb” platform to be specifically deactivated, such that the service is not affected at all at this point. Furthermore, platform Plf1, which has been deactivated, is loaded with the new software and booted up again. Platform Plf1 is assigned a standby operational state and the other states in the quadruple do not change.

The active platform Plf2 in the same redundancy pair is now deactivated, automatically resulting in platform Plf1 switching to the active operational state. The SW upgrade is now operational. The control function Control 1 is available on both platforms again after being out of action for quite a short time. After the new software has been loaded onto platform Plf2, said platform is booted up. Platform Plf2 is assigned a standby state and the other states in the quadruple do not change. Thus the SW upgrade in the redundancy pair (Plf1, Plf2) has been fully completed. Finally, the same procedure is carried out with further redundancy pairs (Plf3, Plf4). Alternatively, to reduce the time required for an upgrade, deactivation and reloading of the STB platforms can take place simultaneously, followed by deactivation and reloading of what were the ACT platforms.

FIG. 3 shows a configuration in a communications system in which the aforementioned architecture has been incorporated. The problem arises here that external devices will not be familiar with the state of the platforms or possibly with the structure of the redundancy units although they monitor the platforms when necessary. Examples of such architectures are server farm architectures in a switching system. In such a system, a server farm usually consists of a server farm controller and a plurality of servers. Using certain criteria, the server farm controller assigns incoming traffic to the servers which are in its view available. In order to ascertain this, it monitors the servers with the aid of a control protocol. If the servers are in fact identical to the platforms of the redundancy units described in the aforementioned, this protocol does not take into account the aforementioned “act/stb” states within the redundancy unit. These states cannot simply be integrated into an existing monitoring mechanism since they in fact operate only in an application-specific manner. This means that for certain applications, even “stb” platforms have to be fully operational. For other applications on the other hand, the function has to be fully deactivated because the redundancy partner is providing the function that can be alternatively activated. Since an “stb” platform is generally active in the view of the operating system and of all the applications which are not in direct connection with the aforementioned redundancy mechanism, the server farm architecture will distribute messages to said platform. This also applies to applications that have to be deactivated on the platform.

Two principles can be used in this case: according to the first principle, the server farm controller uses the platforms in the load sharing operation and issues instructions to all the platforms in a redundancy unit although only one single platform is in a position to act on these instructions according to the redundancy mechanism as per the invention (FIG. 3). For this purpose, what is known as a “relay” function has been incorporated. The relay function causes messages that are sent over an internal communications interface to an “stb” platform (1) to be redirected to its “act” redundancy partner (2), unobserved by the “stb” platform. The active platform processes these messages as if they had come direct from the server farm controller. If an acknowledgement has to be sent back, this is either sent back by the active platform directly to the server farm controller (5) or it goes back via the standby platform (5′), (6′). The relay function is activated only for the applications where the method according to the invention is of relevance and for which it is consequently necessary that all the messages are distributed to active platforms by the server farm controller. In this way the entire redundancy mechanism (redundancy control) remains concealed from the server farm controller. Therefore there is no need for outlay on modifications when incorporating the redundancy control function onto the server farm platforms.

As an alternative hereto, the server farm controller already uses the redundancy unit, in particular a redundancy pair, according to a self-defined active/standby mode, which only occasionally or at least not definitely needs to coincide with that defined by the method according to the invention. In the latter case, the alternative mode of use is established by the responsiveness of the redundancy partner selected by the server farm controller or by explicit, application-specific communication between the redundancy controller selected by the server farm controller and the server farm controller itself. To this end, the platform that is in the standby state deactivates its communication with the server farm controller so that the latter automatically switches over to the remaining activated platform. Alternatively, the application on the platform that has switched from standby mode to active mode informs the server farm controller at application level about the availability of the platform with respect to the application. To this end, an existing or a new interface may optionally be used, as a result of which slight modification costs may possibly be incurred in the server farm controller.

1.-9. (canceled)

10. A method for redundancy control of a plurality of electrical devices, comprising:
monitoring each of the plurality of electrical devices, each of the plurality of electrical devices monitored by a different electrical device in the plurality of electrical devices; and
monitoring within each electrical device of the plurality of electrical devices having redundant internal devices, such that the redundant internal devices monitor each other reciprocally for the respective electrical device,
wherein the monitoring of each of the plurality of electrical devices and the monitoring of the redundant internal devices define, for the respective electrical device, an internal device which is in an active operational state and at least one internal device which is redundant hereto and which is in a standby operational state, and the internal devices exchange with each other control information over a message distribution system.

11. The method as claimed in claim 10, wherein an electrical device in the plurality of electrical devices is monitored by exactly one different electrical device in the plurality of electrical devices.

12. The method as claimed in claim 11, wherein an electrical device in the plurality of electrical devices monitors at least one different electrical device in the plurality of electrical devices.

13. The method as claimed in claim 10, wherein the monitoring within the electrical devices is active only on an electrical device in the plurality of devices currently being monitored by a different electrical device in the plurality of electrical devices.

14. The method as claimed in claim 10, wherein, for an electrical device from the plurality of electrical devices, the active operational state defines itself in terms of the alternative availability of a resource that is available on precisely one internal device of the respective electrical device at a point in time.

15. The method as claimed in claim 14, wherein the resource represents the communications capability over an IP address that is uniform over all internal devices of the respective electrical device.

16. The method as claimed in claim 10, wherein, for an electrical device from the plurality of electrical devices, a control message is provided between the internal devices of the electrical device, the message is transmitted by an internal device in informing the receiving internal device that it is to move into the active or standby operational state.

17. The method as claimed in claim 10, wherein a functionality is provided between the plurality of monitored internal devices of an electrical device of the plurality of electrical devices, such that a message is received by a superordinate device, the message is transmitted to an internal device that is in the standby operational state, and is redirected by the internal device via a communications interface to its redundancy partner, which is in an active operational state.

18. The method as claimed in claim 17, wherein an internal device of an electrical device of the plurality of devices, the internal device being in the standby operational state, deactivates its communication to the superordinate device, such that the superordinate device automatically switches over to the remaining activated platform.
